(19) United States
(12) Patent Application Publication
(10) Pub. No.: US 2013/0008342 A1
(43) Pub. Date: Jan. 10, 2013

(54) GLUE STICK FORMULATED WITH NATURALLY OCCURRING POLYMERS

(75) Inventors: Joginder Kukreja, Brooklin (CA); Van R. Foster, Westerville, OH (US)

(73) Assignee: ELMER'S PRODUCTS, INC., Westerville, OH (US)

(21) Appl. No.: 13/541,208

(22) Filed: Jul. 3, 2012

Related U.S. Application Data
(60) Provisional application No. 61/504,521, filed on Jul. 5, 2011.

(51) Int. Cl. C09J 103/02

(52) U.S. Cl. 106/18; 106/145.5

(57) ABSTRACT

A “green” glue stick formulation that includes at least one starch; casein; and, optionally, a mixture of naturally occurring fatty acids.

### CROSS-REFERENCE TO RELATED APPLICATIONS

This patent application claims the benefit of U.S. Provisional Patent Application Ser. No. 61/504,521, filed on Jul. 5, 2011 and entitled “Glue Stick Formulated with Naturally Occurring Polymers,” the disclosure of which is hereby incorporated by reference herein in its entirety and made part of the present U.S. utility patent application for all purposes.

### BACKGROUND OF THE INVENTION

The present invention relates generally to glue stick products and the like, and more specifically to a glue stick product that includes raw materials derived from renewable sources. Thus, this invention can be described as embodying a “green” product.

Glue sticks are common in the stationery field and are used with paper and other craft materials by both adults and children. Properties such as non-toxicity, ease of application from an appropriate dispenser, and water clean-up are important properties for products of this nature and glue sticks that are commercially available typically possess these or similar features.

Currently, many glue stick products are formulated using synthetic raw materials such as either a PVP or a modified-PVA polymer. PVP-based formulas typically provide better performance than modified-PVA formulas. Ease of lubricity, in-package stability and better adhesion than modified-PVA formulas are characteristic of PVP-based formulas. Although modified PVA-based formulas can be formulated to deliver faster adhesion development, they often lack many of the aforementioned properties of PVP-based formulas. Despite the effectiveness of adhesive products based on synthetic raw materials, the growing interest in “green products” i.e., products that use sustainable raw materials instead of synthetic raw materials, has created a need for products that are derived from natural, renewable sources.

### DETAILED DESCRIPTION OF THE INVENTION

One or more exemplary embodiments of the present invention are now described. Although the following detailed description contains many specifics for purposes of illustration, a person of ordinary skill in the art will appreciate that many variations and alterations to the following details are within the scope of the invention. Accordingly, the following embodiments of the invention are set forth without any loss of generality to, and without imposing limitations upon, the described invention.

The present invention provides a glue stick formulation that is based primarily on sustainable materials. Two exemplary naturally occurring polymers are used to formulate this product, namely starch and casein. Starch (e.g., dextrin) and casein (phosphoproteins) are the two primary ingredients used in this formulation to provide the glue stick of this invention with its bond strength. The combination of these two polymers also provides a balance of important product characteristics including firmness, finger tack, and easy application of the glue stick to a paper surface.

Additional ingredients include palmitic acid and myristic acid, which have melting points of 62.9° C. and 54.4° C., respectively. A soap mixture made with these two naturally-occurring fatty acids provides desired properties for the base of the glue stick, including firmness and ease of application and is compatible with both the starch and casein components. The finished formula provides a product that has a high level of sustainable materials without sacrificing the key properties outlined above.

Having generally described this invention, a further understanding can be obtained by reference to a specific example detailed below, which is provided for purposes of illustration only and is not intended to be all inclusive or limiting unless otherwise specified.

### EXAMPLE

| | % (by wt.) | Description |
|---|---|---|
| Raw Material | | |
| Water | 27.80 | — |
| Ethyl paraben | 0.20 | bactericide |
| Cargill Dryset 07702 | 28.00 | polymer/humectant |
| Glycerin | 6.50 | humectant |
| Borax | 0.90 | tackifier |
| Sodium Metabisulfite | 2.00 | preservative |
| Butyl Zimate slurry | 0.15 | antioxidant |
| Myristic/Palmitic solution* | 13.50 | fatty acid solution |
| 30% Casein solution (in water) | 16.0 | polymer solution |
| 37.4% Sodium hydroxide solution | 2.00 | caustic solution |
| Silane A187 | 0.10 | adhesion promoter |
| | 100.00% | |
| *Myristic/Palmitic solution: | | |
| Water | 54.10 | — |
| Myristic Acid | 5.80 | naturally-occurring fatty |
| | | acid |
| Palmitic Acid | 23.20 | naturally-occurring fatty |
| | | acid |
| Glycerin | 9.9 | humectant |
| 37.4% Sodium Hydroxide soln. | 6.70 | caustic solution |
| Antifoam-C | 0.30 | defoamer |
| | 100.00 | |

With reference to the example provided above, an exemplary process for preparing the glue stick of the present invention includes adding water, ethyl paraben, starch, glycerin, borax, sodium metabisulfite and butyl zimate slurry to a mixer under agitation. The mixing temperature is raised to 75-80° C. and allowed to mix for 30-45 minutes. After mixing into a homogeneous blend, the myristic acid/palmitic acid solution is added and mixed for 15-20 minutes. The casein solution is then added and mixed for 10-15 minutes or until a homogeneous mix is obtained. The caustic solution is added and mixed for 10-15 minutes. Silane A-187 is added last and mixed under vacuum for 5-10 minutes. Glue sticks are traditionally filled using a gravity feed method (i.e., flood filling) which is easily performed due to the very low viscosity of the product at high temperatures. If the formula described above does not flow easily, a positive pressure filling device (i.e., a press) may be used to dispense the formulation into an appropriate glue stick container.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. A glue stick formulation, comprising:
(a) at least one starch;
(b) casein; and
(c) optionally, a mixture of naturally occurring fatty acids.

2. The formulation of claim 1, wherein the at least one starch is dextrin.

3. The formulation of claim 1, wherein the mixture of naturally occurring fatty acids further includes myristic acid and palmitic acid.

4. The formulation of claim 1, further comprising water.

5. The formulation of claim 1, further comprising at least one bactericide.

6. The formulation of claim 1, further comprising at least one humectant.

7. The formulation of claim 1, further comprising at least one tackifier.

8. The formulation of claim 1, further comprising at least one preservative.

9. The formulation of claim 1, further comprising at least one antioxidant.

10. The formulation of claim 1, further comprising a solution of sodium hydroxide.

11. The formulation of claim 1, further comprising at least one adhesion promoter.

12. The formulation of claim 1, further comprising at least one anti-foaming agent.

13. A glue stick formulation, comprising:
(a) at least one starch;
(b) casein; and
(c) a solution of naturally occurring fatty acids, wherein the solution of naturally occurring fatty acids further includes myristic acid and palmitic acid.

14. The formulation of claim 13, further comprising water.

15. The formulation of claim 13, further comprising ethyl paraben.

16. The formulation of claim 13, further comprising glycerin.

17. The formulation of claim 13, further comprising borax.

18. The formulation of claim 13, further comprising sodium metabisulfite.

19. The formulation of claim 13, further comprising butyl zimate.

20. The formulation of claim 13, further comprising a solution of sodium hydroxide.

21. The formulation of claim 13, further comprising silane.

22. The formulation of claim 13, further comprising at least one anti-foaming agent.
